(19) United States
(12) Patent Application Publication
(10) Pub. No.: US 2011/0170234 A1
(43) Pub. Date: Jul. 14, 2011

(54) Electric double layer capacitor

(75) Inventors: Sung Ho Lee, Seongnam (KR); Chang Ryul Jung, Seoul (KR); Wan Suk Yang, Seoul (KR); Hyun Chul Jung, Yongin (KR); Yeong Su Cho, Guri (KR)

(73) Assignee: SAMSUNG ELECTRO-MECHANICS CO., LTD., Suwon (KR)

(21) Appl. No.: 12/801,951

(22) Filed: Jul. 2, 2010

(30) Foreign Application Priority Data
Jan. 12, 2010 (KR) 10-2010-0002881

(51) Int. Cl. H01G 9/155; H01G 9/02; H01G 9/08

(52) U.S. Cl. 361/502

(57) ABSTRACT

There is provided an electric double layer capacitor including: a multilayer electric double layer capacitor cell including first and second electrodes facing each other with an ion-permeable separator interposed therebetween; and an insulating tape with which to enclose an outer surface of the multilayer electric double layer capacitor cell and having a plurality of pores. In the electric double layer capacitor, movements between the first and second electrodes and the ion-permeable separator are minimized so that the area of the facing surfaces of the first and second electrodes increases. Accordingly, high capacitance may be achieved. In addition, the pores formed in the insulating tape facilitate the path of an electrolyte so that the impregnation of the electrolyte into the multilayer electric double layer capacitor cell is thereby facilitated.

### CROSS-REFERENCE TO RELATED APPLICATIONS

This application claims the priority of Korean Patent Application No. 10-2010-0002881 filed on Jan. 12, 2010, in the Korean Intellectual Property Office, the disclosure of which is incorporated herein by reference.

### BACKGROUND OF THE INVENTION

1. Field of the Invention

The present invention relates to an electric double layer capacitor, and more particularly, to an electric double layer capacitor having high capacitance and low resistance.

2. Description of the Related Art

In various electronic products such as information communication devices, a stable energy supply is considered to be an important element. In general, such a function is performed by a capacitor. That is, the capacitor serves to store electricity in a circuit provided in various electronic products such as information communication devices and then discharge the electricity, thereby stabilizing the flow of electricity within the circuit. A general capacitor has a short charge and discharge time, a long lifespan, and high output density. However, since the general capacitor has low energy density, there is a limitation in using the capacitor as a storage device.

To overcome such a limitation, a new category of capacitors such as electric double layer capacitors have recently been developed, which have a short charge and discharge time and high output density. A great deal of attention is being paid to such capacitors as next generation energy devices together with secondary cells.

The electric double layer capacitor is an energy storage device using a pair of electrodes having different polarities. The electric double layer capacitor may perform continuous electrical charge and discharge cycles and have higher energy efficiency and output as well as greater durability and stability than other, more general capacitors. Accordingly, the electric double layer capacitor which may be charged and discharged with high current is being recognized as a storage device which may be charged and discharged at a high frequency, such as an auxiliary power supply for mobile phones, an auxiliary power supply for electric vehicles, and an auxiliary power supply for solar cells.

A basic structure of the electric double layer capacitor includes an electrode, an electrolyte, a current collector, and a separator. The electrode thereof, such as a porous electrode, has a relatively large surface area. The operational principle of the electric double layer capacitor is an electro-chemical mechanism in which electricity is generated when a voltage of several volts is applied to both ends of a unit cell electrode such that ions contained in the electrolyte move along an electric field to be adsorbed by an electrode surface.

In general, a capacitor cell is formed by stacking unit cells, each of which is constructed by stacking a pair of electrodes having a sheet of separator disposed therebetween. Here, as the overlapping area of the pair of electrodes increases and electrolyte movement becomes smoother, a capacitor achieves increased capacitance.

### SUMMARY OF THE INVENTION

An aspect of the present invention provides an electric double layer capacitor having high capacitance and low resistance.

According to an aspect of the present invention, there is provided an electric double layer capacitor including: a multilayer electric double layer capacitor cell including first and second electrodes facing each other with an ion-permeable separator interposed therebetween; and an insulating tape with which to enclose an outer surface of the multilayer electric double layer capacitor cell and having a plurality of pores.

The insulating tape may enclose the entirety of the outer surface of the multilayer electric double layer capacitor cell.

The insulating tape may enclose part of the outer surface of the multilayer electric double layer capacitor cell.

The insulating tape may include a plurality of insulating tape bands spaced apart from each other and enclosing part of the outer surface of the multilayer electric double layer capacitor cell.

The multilayer electric double layer capacitor cell may be a unit cell including a first electrode, a second electrode, and an ion-permeable separator interposed therebetween.

The multilayer electric double layer capacitor cell may have a plurality of unit cells stacked upon one another, the plurality of unit cells each including a first electrode, a second electrode, and an ion-permeable separator interposed therebetween.

The ion-permeable separator may include a plurality of openings having an average diameter of 0.1 mm to 1.0 mm.

The multilayer electric double layer capacitor cell may further include first and second current collectors formed on the first and second electrodes, respectively.

According to another aspect of the present invention, there is provided an electric double layer capacitor including a multilayer electric double layer capacitor cell including first and second electrodes facing each other with an ion-permeable separator interposed therebetween. The ion-permeable separator includes a plurality of openings having an average diameter of 0.1 mm to 1.0 mm.

The multilayer electric double layer capacitor cell may have a plurality of unit cells stacked upon one another, the plurality of unit cells each including a first electrode, a second electrode, and an ion-permeable separator interposed therebetween.

The multiplayer electric double layer capacitor cell may further include first and second current collectors formed on the first and second electrodes, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view illustrating an electric double layer capacitor according to an exemplary embodiment of the present invention;

FIG. 1B is a schematic cross-sectional view illustrating the electric double layer capacitor of FIG. 1A, taken along line I-I′;

FIG. 2 is a schematic perspective view illustrating a unit cell included in an electric double layer capacitor according to an exemplary embodiment of the present invention;

FIG. 3 is a schematic perspective view illustrating an electric double layer capacitor according to another exemplary embodiment of the present invention; and

FIG. 4 is a schematic perspective view illustrating an electric double layer capacitor according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. It should be considered that the shapes and dimensions of elements in the drawings may be exaggerated for clarity. Throughout the drawings, the same reference numerals will be used to designate the same or like elements.

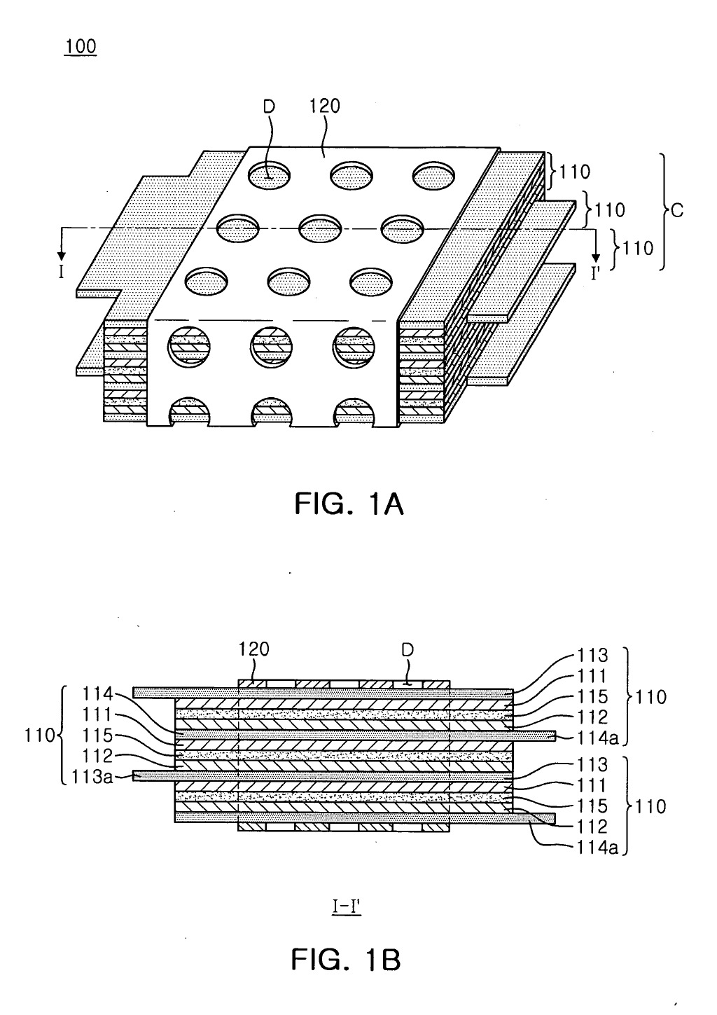

FIG. 1A is a schematic perspective view illustrating an electric double layer capacitor according to an exemplary embodiment of the present invention. FIG. 1B is a schematic cross-sectional view illustrating the electric double layer capacitor of FIG. 1A, taken along line I-I′.

With reference to FIGS. 1A and 1B, an electric double layer capacitor 100 according to this embodiment includes a multilayer electric double layer capacitor cell C and an insulating tape 120 with which to enclose the multilayer electric double layer capacitor cell C.

The multilayer electric double layer capacitor cell C includes a first electrode 111 and a second electrode 112 that face each other, and an ion-permeable separator 115 interposed therebetween.

The first and second electrodes 111 and 112 and the ion-permeable separator 115 constitute a unit cell 110 of the electric double layer capacitor 100. When a plurality of unit cells are stacked, higher capacitance may be achieved. In this embodiment, there is provided the multilayer electric double layer capacitor cell C in which the plurality of unit cells 110 are stacked.

Although not shown, the multilayer electric double layer capacitor cell C may be configured to include a single unit cell.

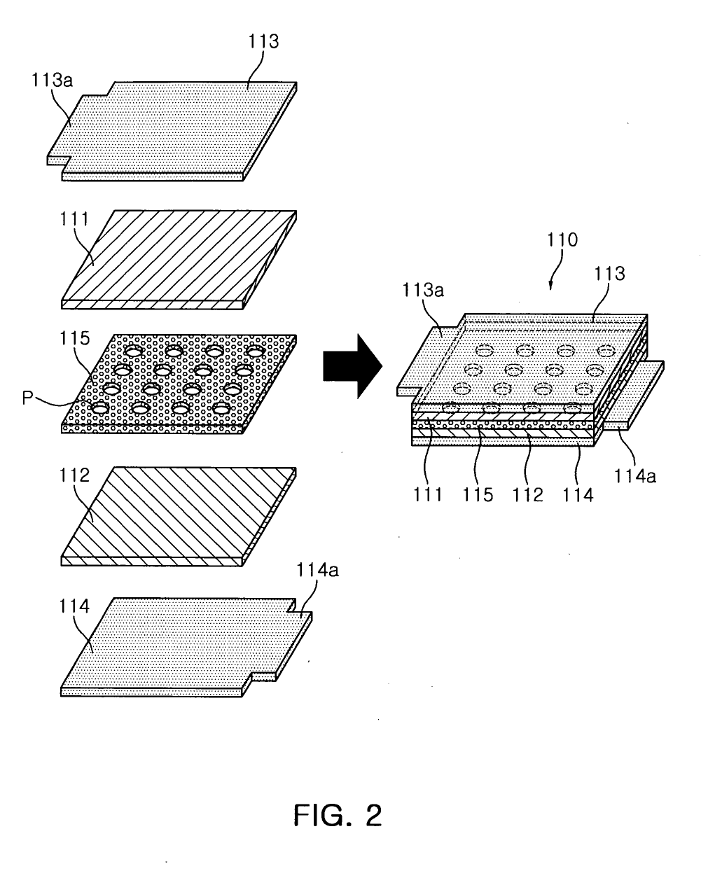

FIG. 2 is a schematic perspective view illustrating a unit cell included in an electric double layer capacitor according to an exemplary embodiment of the present invention.

According to this embodiment, the unit cell 110 of the electric double layer capacitor 100 includes the first and second electrodes 111 and 112 facing each other with the ion-permeable separator 115 interposed therebetween.

First and second current collectors 113 and 114 may be formed on the first and second electrodes 111 and 112, respectively.

The first and second electrodes 111 and 112 may be formed by applying electrode material to the first and second current collectors 113 and 114. The first and second current collectors 113 and 114 may have first and second terminal lead-out portions 113a and 114a on which electrode material is not formed.

The electrode material is not particularly limited. As the electrode material available in this art, for example, activated carbon with a relatively high specific surface area may be used.

The first and second current collectors 113 and 114 are conductive sheets for transferring an electrical signal to the first and second electrodes 111 and 112, respectively. The first and second current collectors 113 and 114 may be formed of a conductive polymer, a rubber sheet, or a metallic foil.

The shapes of the first and second current collectors 113 and 114 may be properly modified in such a manner that they are electrically connected to terminals (not shown) for transferring an electrical signal to the electric double layer capacitor. For example, after the plurality of unit cells 110 are stacked, the plurality of first and second terminal lead-out portions 113a and 114a of the plurality of first and second current collectors 113 and 114 may be brought together such that they may have a partially bent shape.

When the first and second electrodes 111 and 112 do not include the first and second current collectors 113 and 114, the first and second electrodes 111 and 112 may be manufactured by making electrode material into a solid-state sheet.

The ion-permeable separator 115 may be formed of a porous material through which ions can permeate. For example, a porous material such as polypropylene, polyethylene, or glass fiber may be used.

Since the ion-permeable separator 115 is formed of a porous material, the ion-permeable separator 115 includes pores in that material itself. In this embodiment, the ion-permeable separator 115 includes a plurality of openings P besides the pores.

In general, pores included in an ion-permeable separator have an average diameter on a μm scale. In this embodiment, the openings P may have an average diameter on a mm scale. More specifically, the openings P may be 0.1 mm to 1.0 mm in average diameter.

In the electric double layer capacitor, ions in an electrolyte move along an electric field to be adsorbed by an electrode surface.

Here, the ions in the electrolyte pass through the ion-permeable separator 115 so that they are absorbed by the electrode surface. In this embodiment, the ion-permeable separator 115 includes relatively large-sized openings as well as pores so that the movement of the ions therethrough is thereby facilitated.

Therefore, a path for the ions may be secured, without any limitations in the viscosity of the electrolyte and the size of the ions, thereby reducing resistance. Also, during an electrolyte impregnation process, the electrolyte may be easily permeated into the multilayer electric double layer capacitor cell.

According to this embodiment, the electric double layer capacitor 100 includes the insulating tape 120 with which to enclose the multilayer electric double layer capacitor cell C.

In this embodiment, the first and second electrodes 111 and 112 facing each other with the ion-permeable separator 115 interposed therebetween are stacked to form the unit cell 110 of the electric double layer capacitor 100. Such a unit cell 110 is stacked to form the multilayer electric double layer capacitor cell C.

In the stacking of the first and second electrodes and the ion-permeable separator, the multilayer electric double layer capacitor cell may be wrapped with the insulating tape in order to maximize the overlapping area of the two electrodes while minimizing movement between the electrodes and the ion-permeable separator.

Then, the multilayer electric double layer capacitor cell, having been wrapped with the insulating tape, is impregnated with the electrolyte in a vacuum. Through the electrolyte impregnation process, the electrolyte should be deeply permeated into the multilayer electric double layer capacitor cell as well as sufficiently wetting the multilayer electric double layer capacitor cell.

The electrolyte includes cations and anions. When voltage is applied thereto, the cations and the anions move in opposing electrodes, respectively, thereby being absorbed.

However, a portion of the multilayer electric double layer capacitor cell, wrapped with the insulating tape, may cause difficulty in the rapid permeation of the electrolyte. Also, the permeation of the electrolyte may be influenced by the viscosity of the electrolyte, the size of the ions, and the path of the ions. The path of the electrolyte may be interrupted by the insulating tape.

When the electrolyte fails to sufficiently permeate into the multilayer electric double layer capacitor cell, the charging and discharging function of the electric double layer capacitor may not be properly realized. This problem becomes worse as the number of stacked unit cells increases.

According to this embodiment, the insulating tape 120 includes a plurality of pores D. The pores D facilitate the impregnation of the electrolyte into the electric double layer capacitor cell. The insulating tape 120 may facilitate the path of the electrolyte therethrough while at the same time maintaining the stacked structure of the electrodes and the ion-permeable separator.

The shape of the pores D is not particularly limited, and it may be variously designed to be circular, triangular, quadrangular, or the like.

The size of the pores D is not particularly limited, and it may be properly selected in consideration of the size of the multilayer electric double layer capacitor cell, the type of the electrolyte, and the like. For example, the pores D may be 0.1 mm to 5.0 mm in average diameter.

Also, the insulating tape 120 may enclose the entirety of the outer surface of the multilayer electric double layer capacitor cell. The area enclosed by the insulating tape 120 may be the same as that of the entire outer surface of the multilayer electric double layer capacitor cell.

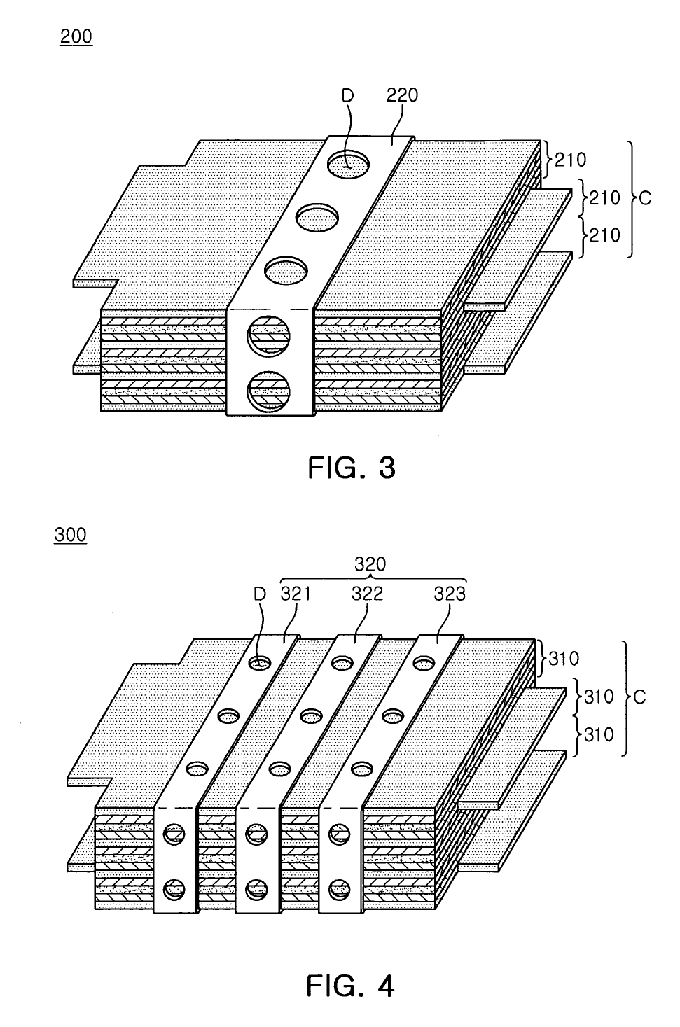

FIG. 3 is a schematic perspective view illustrating an electric double layer capacitor according to another exemplary embodiment of the present invention. A detailed description of elements different from those of the aforementioned embodiment will be provided, while a detailed description of the same elements will be omitted.

With reference to FIG. 3, an electric double layer capacitor 200 according to this embodiment includes a multilayer electric double layer capacitor cell C and an insulating tape 220 with which to enclose the multilayer electric double layer capacitor cell C.

A plurality of unit cells 210 are stacked to form the multilayer electric double layer capacitor cell C, part of which is wrapped with the insulating tape 220. The insulating tape 220 minimizes movements between first and second electrodes and an ion-permeable separator and facilitates the impregnation of an electrolyte. Also, in this embodiment, since the area in which the insulating tape 220 is formed is small, the area in which the permeation of the electrolyte is interrupted is also small.

FIG. 4 is a schematic perspective view illustrating an electric double layer capacitor according to another exemplary embodiment of the present invention. A detailed description of elements different from those of the aforementioned embodiment will be provided, while a detailed description of the same elements will be omitted.

With reference to FIG. 4, an electric double layer capacitor 300 according to this embodiment includes a multilayer electric double layer capacitor cell C and an insulating tape 320 with which to enclose the multilayer electric double layer capacitor cell C.

A plurality of unit cells 310 are stacked to form the multilayer electric double layer capacitor cell C. A plurality of insulating tape bands 321, 322 and 323 enclose the multilayer electric double layer capacitor cell C. The insulating tape 320 includes the plurality of insulating tape bands spaced apart from each other and enclosing part of the outer surface of the multilayer electric double layer capacitor cell C.

The insulating tape 320 minimizes movement between first and second electrodes and an ion-permeable separator and facilitates the impregnation of an electrolyte thereinto. Also, in this embodiment, since the area where the insulating tape 320 is formed is small, the area where the permeation of the electrolyte is interrupted is also small.

As set forth above, according to exemplary embodiments of the invention, a multilayer electric double layer capacitor cell is wrapped with an insulating tape having a plurality of pores.

The insulating tape minimizes movements between first and second electrodes and an ion-permeable separator so that the area of the facing surfaces of the first and second electrodes increases. Accordingly, high capacitance may be achieved.

Also, pores formed in an insulating tape facilitate the path of an electrolyte so that the impregnation of the electrolyte into a multilayer electric double layer capacitor cell is facilitated.

Furthermore, an ion-permeable separator included in a multilayer electric double layer capacitor cell has a plurality of openings so that a path for ions may be secured without any limitations in the viscosity of the electrolyte and the size of the ions, whereby resistance may be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An electric double layer capacitor comprising:
a multilayer electric double layer capacitor cell including first and second electrodes facing each other with an ion-permeable separator interposed therebetween; and
an insulating tape with which to enclose an outer surface of the multilayer electric double layer capacitor cell and having a plurality of pores.

2. The electric double layer capacitor of claim 1, wherein the insulating tape encloses the entirety of the outer surface of the multilayer electric double layer capacitor cell.

3. The electric double layer capacitor of claim 1, wherein the insulating tape encloses part of the outer surface of the multilayer electric double layer capacitor cell.

4. The electric double layer capacitor of claim 1, wherein the insulating tape comprises a plurality of insulating tape bands spaced apart from each other and enclosing part of the outer surface of the multilayer electric double layer capacitor cell.

5. The electric double layer capacitor of claim 1, wherein the multilayer electric double layer capacitor cell is a unit cell including a first electrode, a second electrode, and an ion-permeable separator interposed therebetween.

6. The electric double layer capacitor of claim wherein the multilayer electric double layer capacitor cell has a plurality of unit cells stacked upon one another, the plurality of unit cells each including a first electrode, a second electrode, and an ion-permeable separator interposed therebetween.

7. The electric double layer capacitor of claim 1, wherein the ion-permeable separator includes a plurality of openings having an average diameter of 0.1 mm to 1.0 mm.

8. The electric double layer capacitor of claim 1, wherein the multilayer electric double layer capacitor cell further comprises first and second current collectors formed on the first and second electrodes, respectively.

9. An electric double layer capacitor comprises a multilayer electric double layer capacitor cell including first and second electrodes facing each other with an ion-permeable separator interposed therebetween,
wherein the ion-permeable separator includes a plurality of openings having an average diameter of 0.1 mm to 1.0 mm.

10. The electric double layer capacitor of claim 9, wherein the multilayer electric double layer capacitor cell has a plurality of unit cells stacked upon one another, the plurality of unit cells each including a first electrode, a second electrode, and an ion-permeable separator interposed therebetween.

11. The electric double layer capacitor of claim 9, wherein the multiplayer electric double layer capacitor cell further comprises first and second current collectors formed on the first and second electrodes, respectively.
